(19) United States
(12) Patent Application Publication
(10) Pub. No.: US 2026/0197330 A1
(43) Pub. Date: Jul. 9, 2026

(54) UNAUTHORIZED DATA TRANSFER DETECTION

(71) Applicant: HEWLETT PACKARD ENTERPRISE DEVELOPMENT LP, Spring, TX (US)

(72) Inventor: Thomas Golway, Plandome, NY (US)

(21) Appl. No.: 19/013,858

(22) Filed: Jan. 8, 2025

(51) Int. Cl. H04L 9/40; G06F 21/44

(52) U.S. Cl. CPC H04L 63/1425; G06F 21/44

(57) ABSTRACT

In some examples, a system receives a collection of values of a plurality of metrics including a resource utilization metric representing utilization of a resource, and a data communication metric representing communication of data. The system detects an anomalous behavior of a first metric of the plurality of metrics. Based on detecting the anomalous behavior of the first metric, the system computes a measure of correlation between the first metric and at least a second metric of the plurality of metrics. The system determines whether an unauthorized data transfer is occurring based on the measure of correlation.

### BACKGROUND

Attackers can infiltrate computing systems to gain unauthorized access to data or functions of the computing systems. For example, malware can be introduced into a computing system and perform unauthorized operations.

### BRIEF DESCRIPTION OF THE DRAWINGS

Some implementations of the present disclosure are described with respect to the following figures.

FIG. 1 is a block diagram of a computing system including an exfiltration detection engine, according to some examples.

FIG. 2 is a flow diagram of an exfiltration detection process, according to some examples.

FIG. 3 is a block diagram of a storage medium storing machine-readable instructions according to some examples.

FIG. 4 is a block diagram of a system according to some examples.

FIG. 5 is a flow diagram of a process according to some examples.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

Data exfiltration is an example type of attack in which an attacker performs an unauthorized transfer of data from a computing system to one or more destinations. Data exfiltration can lead to financial loss, reputation damage, operational disruption, legal or regulatory violations, or other risks and consequences. Data exfiltration techniques have become increasingly sophisticated to avoid detection. Attackers may employ techniques to obscure their activities to evade detection by a security system. Examples of obscuring techniques can include any or some combination of the following: data fragmentation to fragment a large dataset into fragments to reduce the size of the exfiltrated data; data compression to reduce the size of the exfiltrated data; distributed exfiltration in which data is transferred from multiple sources to multiple destinations to reduce the concentration of the exfiltration activity; stenography in which exfiltrated data is hidden within other objects such as an image file, an audio file, a video file, etc., so that the exfiltrated data can be disguised; data encryption to encrypt the exfiltrated data to blend with legitimate encrypted communications; an advanced persistent threat (APT) technique in which an attack is performed over a prolonged time period to evade detection; or program code mutation in which malware is mutated to avoid detection, such as by use of oligomorphic malware, metamorphic malware, or polymorphic malware.

Alternatively or additionally, attackers can also leverage a microservices architecture of a computing system to avoid detection. The microservices architecture includes a collection of services (referred to as microservices) for implementing software, where the services are loosely coupled, such as through an application programming interface (API). An attacker can exploit the flexibility and complexity inherent in the microservices architecture, by embedding malicious code into microservices and/or creating rogue microservices to discreetly collect and transmit data. Attackers can mask the data exfiltration due to the distributed nature of operations of the microservices. As a result, security systems may not be able to reliably detect data exfiltration attacks in the microservices architecture.

In accordance with some implementations of the present disclosure, an unauthorized data transfer detection system detects an occurrence of an unauthorized data transfer based on a statistical analysis of a first collection of metrics to determine whether a first metric exhibiting an anomalous behavior correlates with at least another metric of the collection of metrics. In response to detecting that the first metric is exhibiting the anomalous behavior, the unauthorized data transfer detection system checks a relationship of the first metric to one or more other metrics to determine whether an unauthorized data transfer may be occurring.

If so, the unauthorized data transfer detection system monitors a new collection of metrics to determine whether the new collection of metrics exhibits a new pattern that differs from the pattern of the first collection of metrics. If the new collection of metrics exhibits the new pattern that differs from the pattern of the first collection of metrics, then that indicates that the unauthorized data transfer is likely occurring.

Techniques or mechanisms according to some examples of the present disclosure improve computer functionality by more reliably detecting unauthorized data transfers that can raise computer security issues, adversely impact operations of a computing system, or lead to loss of data. The detection of unauthorized data transfers may be accomplished even when an attacker implements techniques to obscure the attacker's activities.

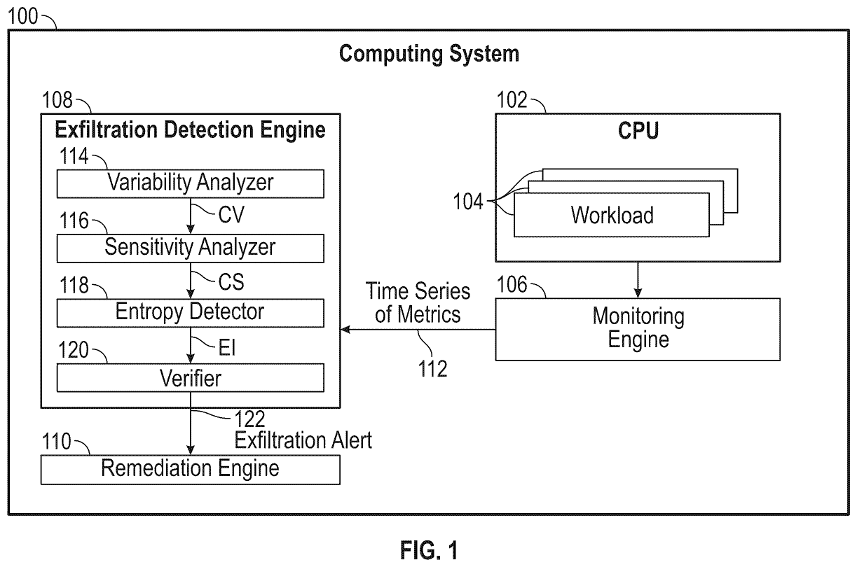

FIG. 1 is a block diagram of a computing system 100, which can be implemented with one or more computers. The computing system 100 includes a central processing unit (CPU) 102, which includes one or more hardware processors. Although just one CPU is shown in FIG. 1, the computing system 100 may include multiple CPUs. The CPU 102 can execute workloads 104, such as workloads of application programs, operating systems, system firmware, and so forth. In some examples, the workloads 104 may be executed in a virtualized computing environment. The virtualized computing environment may include virtual compute entities, such as containers or virtual machines (VMs). In further examples, some workloads 104 may include microservices.

The computing system 100 also includes a monitoring engine 106, an exfiltration detection engine 108, and a remediation engine 110. Although depicted as separate modules, two or more of the monitoring engine 106, exfiltration detection engine 108, and remediation engine 110 may be integrated into the same engine.

In some examples, the monitoring engine 106 and the exfiltration detection engine 108 can be implemented using machine-readable instructions executed by a processing resource of the computing system 100. The processing resource can include one or more hardware processors. The processing resource may be separate from the CPU 102. In other examples, the monitoring engine 106 and the exfiltration detection engine 108 may be executed on different processing resources.

The remediation engine 110 can be executed by the same processing resource as the monitoring engine 106 and the exfiltration detection engine 108, or alternatively, the remediation engine 110 can be executed by a processing resource that is separate from the processing resource(s) used to execute the monitoring engine 106 and the exfiltration detection engine 108. In further examples, the remediation engine 110 can be external of the computing system 100.

The monitoring engine 106 can take measurements associated with execution of the workloads 104. Examples of measurements that can be acquired by the monitoring engine 106 include measurements relating to usage or performance of resources, such as the CPU 102, a memory, storage, a network, an input/output (I/O) resource, or any other type of resource of the computing system 100. The measurements are represented by metrics that are sent by the monitoring engine 106 to the exfiltration detection engine 108. A “metric” can include a parameter (or a collection of parameters) representing the utilization or performance of a resource.

The metrics can be provided by the monitoring engine 106 to the exfiltration detection engine 108 as a time series of metrics 112. A time series of metrics includes metrics collected at different time points.

Based on the metrics in the time series of metrics 112, the exfiltration detection engine 108 can determine if data exfiltration is likely occurring in the computing system 100. For example, one or more of the workloads 104 may be performed or initiated by malware inside the computing system 100 or outside the computing system 100.

The exfiltration detection engine 108 includes a variability analyzer 114, a sensitivity analyzer 116, an entropy detector 118, and a verifier 120. Although depicted as different blocks, functions of the variability analyzer 114, the sensitivity analyzer 116, the entropy detector 118, and the verifier 120 can be combined into fewer blocks or divided among more blocks.

In some examples of the present disclosure, the exfiltration detection engine 108 implements an advanced temporal inference algorithm to detect anomalies in real time, i.e., as metrics are received from the monitoring engine 106. In specific examples, the exfiltration detection engine 108 may focus on the correlation between specific metrics, such as metrics representing CPU utilization and data flow of the workloads 104. The data flow of the workloads 104 may be represented by a ratio of data ingested by the workloads 104 to data sent by the workloads 104. CPU utilization refers to the usage of the CPU 102 (or multiple CPUs). Data ingested by the workloads 104 refers to an amount of data input into the workloads 104, and data sent by the workloads 104 refers to an amount of data output by the workloads 104. The ratio of data ingested by the workloads 104 to data sent by the workloads 104 is computed by dividing the amount of data input into the workloads 104 by the amount of data output by the workloads 104 (or vice versa). By monitoring the correlation between CPU utilization and data flow of the workloads 104, the exfiltration detection engine 108 can identify potential data exfiltration in real time.

In some examples, the exfiltration detection engine 108 uses a chain of algorithms based on the principles of mathematical chaos theory to continually monitor workload behavior for the purpose of detecting anomalies. When deployed and running, the consumption of resources (e.g., CPU, memory, storage, network, I/O resource, etc.) by the workloads 104 (when not compromised by an attacker) should exhibit a behavior known in chaos theory as “self-similarity.” The workloads 104 when not compromised by an attacker operate in a “normal” state. The “self-similarity”of metrics refers to metrics having sensitive dependencies on each other; in other words, a variation of a first metric should trigger a change to all metrics proportionate to the change of the first metric, and the metrics should retain their statistical properties.

The exfiltration detection engine 108 performs a statistical analysis of a collection of metrics (e.g., the time series of metrics 112) collected by the monitoring engine 106. As part of the statistical analysis, the variability analyzer 114 generates a coefficient of variability, CV, which is a parameter indicating whether a metric (in the time series of metrics 112) received from the monitoring engine 106 is exhibiting an anomalous behavior. For example, CV may indicate whether an observed value of the metric has deviated from an expected metric value by greater than a behavior variation tolerance (BVt). For multiple metrics of the time series of 112, the variability analyzer 114 can generate respective CVs for the multiple metrics.

It is expected that if a first metric exhibits a variation indicating that the first metric has deviated from an expected range of values (e.g., based on CV for the first metric), then other metrics should exhibit a proportionate variation. Based on the CVs from the variability analyzer 114, the sensitivity analyzer 116 generates a coefficient of sensitivity, CS, which represents a correlation between multiple metrics. The sensitivity analyzer 116 may compute CS in response to detecting that at least one metric is exhibiting an anomalous behavior (based on the CV for the metric).

If CS violates a sensitivity criterion, e.g., CS violates a sensitivity variation tolerance (SVt), then the entropy detector 118 can make a determination that entropy may have been detected. Based on CS, the entropy detector 118 determines whether the other metrics exhibit the proportionate variation relative to the first metric (e.g., whether self-similarity of the metrics is maintained).

If CS indicates that the self-similarity of metrics has been violated (e.g., CS violates SVt), then the entropy detector 118 can output an entropy indicator (EI) to the verifier 120. EI can be in the form of a signal or information element set to a specified state or value (e.g., “1” or “0” or any other state or value). The entropy indicator (EI) indicates that an unexpected condition may be present in the computing system 100, e.g., the workloads 104 are no longer operating in their normal state. The entropy may potentially be caused by data exfiltration performed by an attacker.

In response to EI, the verifier 120 analyzes a new time series of metrics. The new time series of metrics is distinct from the time series of metrics 112 (the time series of metrics 112 may be referred to as the “original” time series of metrics). For example, the metrics in the new time series of metrics may be at time points that are completely different from the time points of the original time series of metrics 112. As another example, there may be some overlap in time points between the new time series of metrics and the original time series of metrics 112.

The new time series of metrics can include a specific quantity of samples of metrics, e.g., 100 (or a different quantity of) samples of metrics at respective time points. The verifier 120 analyzes the new time series of metrics to confirm that the new time series is exhibiting a new pattern (that differs from the pattern of the original time series of metrics) indicative of entropy. If the new time series of metrics exhibits the new pattern that differs from the pattern of the original time series of metrics 112, then the verifier 120 can produce an exfiltration alert 122. The exfiltration alert 122 can be in the form of an information element, a message, a signal, or any other indicator.

The verifier 120 computes CVs and CSs for the metrics in the new time series of metrics. In some examples, the verifier 120 compares an average of the CVs and CSs computed at the time points of the new time series of metrics to the average of the CVs and CSs computed for the original time series of metrics 112. In an example, CV0 is the average of the CVs of the original time series of metrics 112, and CS0 is the average of the CSs of the original time series of metrics 112. CV0 and CS0 may be previously computed by the exfiltration detection engine 108 and stored.

For example, if there are 100 samples of metrics in the new time series of metrics, then 100 CV and CS values, {CV1, CV2, . . . , CV100} and {CS1, CS2, . . . , CS100}, may be computed by the verifier 120. In an example, the verifier 120 computes the average of {CV1, CV2, . . . , CV100} to produce CV_{avg}, and the verifier 120 computes the average of {CS1, CS2, . . . , CS100} to produce CS_{avg}. The verifier 120 also retrieves CV0 and CS0, where CV0 is the average of the CVs of the original time series of metrics 112, and CS0 is the average of the CSs of the original time series of metrics 112. The verifier 120 can compare CV_{avg} to CV0 and compare CS_{avg} to CS0. If CV_{avg} is within a threshold difference of CV0 and CSang is within the threshold difference of CS0, then the verifier 120 makes a determination that the new time series of metrics exhibits the “same” pattern as the original time series of metrics 112. The new time series of metrics exhibiting the same pattern as the original time series of metrics 112 indicates that the entropy indicator (EI) issued by the entropy detector 118 was caused by a transient deviation in metric values, and thus data exfiltration is likely not occurring.

However, if the new time series of metrics does not exhibit the same pattern as the original time series of metrics 112, i.e., the new time series is exhibiting a new pattern, then the verifier 120 can make a determination that data exfiltration is likely occurring.

In another example, instead of comparing average CV and CS values of the new and original time series of metrics, the verifier 120 can determine how many CV and CS values computed for the new time series match CV0 and CS0. For example, if each of at least some specified number of CV values from {CV1, CV2, . . . , CV100} differs from CV0 by less than the threshold difference, and each of at least some specified number of CS values from {CS1, CS2, . . . , CS100} differs from CS0 by less than the threshold difference, then the verifier 120 can make a determination that the new time series of metrics shows the same pattern as the metrics in the original time series of metrics 112. The “specified number” of CV and CS values can be X % of the CV from {CV1, CV2, . . . , CV100} and X % of the CS values from {CS1, CS2, . . . , CS100}, where X can be any of the following: 100, 95, 90, 85, 80, etc. As an example, if X=70, then the verifier 120 can make a determination that the new time series of metrics shows the same pattern as the metrics in the original time series of metrics 112 if each of 70% of the CV from {CV1, CV2, . . . , CV100} differs from CV0 by less than the threshold difference, and each of 70% of the CS values from {CS1, CS2, . . . , CS100} differs from CS0 by less than the threshold difference.

Using techniques or mechanisms according to some examples of the present disclosure, the exfiltration detection engine 108 is able to detect patterns in metrics that are indicative of an unauthorized data transfer, even if an attacker attempts to obfuscate the unauthorized data transfer using any of the obfuscation techniques discussed further above.

The exfiltration alert 122 is provided to the remediation engine 110. In response to the exfiltration alert 122, the remediation engine 110 can trigger one or more remediation actions, which can include any or some combination of the following: disabling the computing system 100 (e.g., disabling a network connectivity of the computing system 100, shutting down the computing system 100, disabling programs in the computing system 100, etc.), sending an alert to a target entity (e.g., a human administrator, a program, or a machine), or any other remediation action.

In examples in which the exfiltration detection engine 108 monitors metrics representing CPU utilization and data flow, the exfiltration detection engine 108 checks if a variation in values of a metric representing CPU utilization (“CPU utilization metric”) correlates closely with the ratio of data ingested (input) and data sent (output). The ratio is referred to as a “ratio of input and output data” and is represented by a data ratio metric. As data is ingested and processed and subsequently output, CPU utilization increases proportionally during the normal state of the workloads 104. However, if data exfiltration is present, then the exfiltration detection engine 108 may observe a large increase in data flow but low CPU utilization. When data exfiltration occurs, CPU utilization drops below expected levels relative to the data input/output ratio. This discrepancy arises because the CPU is not processing the data but merely passing the data through, indicating a potential data leak. This discrepancy can be detected by the exfiltration detection engine 108 based on the statistical analysis of the metrics.

As noted above, obfuscation techniques implemented by an attacker may include data fragmentation, data compression, and/or data encryption. If data is being fragmented, compressed, or encrypted, CPU utilization may increase beyond an expected range for a given data input/output ratio. This discrepancy can also be detected by the exfiltration detection engine 108.

In some examples, the metrics provided by the monitoring engine 106 can include any or some combination of the following: a CPU utilization metric, a data input metric representing the amount of input data, a data output metric representing the amount of output data, a storage read metric representing the amount of data read from storage, a memory access metric representing the amount of data read from memory, or any other metric.

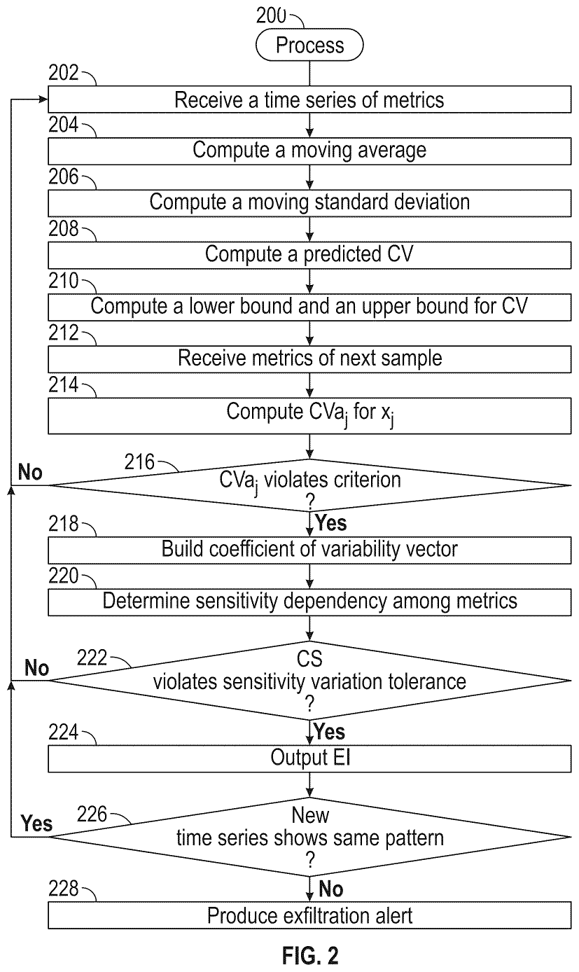

FIG. 2 is a flow diagram of a process 200 of the exfiltration detection engine 108, according to some examples of the present disclosure. The exfiltration detection engine 108 has various settings that can affect the operations of the exfiltration detection engine 108. The settings can include any or some combination of the following: SR, which represents the sampling rate at which metrics are collected by the monitoring engine 106 and provided to the exfiltration detection engine 108 (e.g., the metrics are sampled once every Y milliseconds, where Y is a positive number); BVt, which is the behavior variation tolerance that can be expressed as a percentage, for example; SVt, which is the sensitivity variation tolerance that can be expressed as a percentage; and E (0), which represents the number of consecutive anomalous behavior events that constitute an entropic event.

The values of the various settings may be dependent upon the types of workloads 104 being monitored by the exfiltration detection engine 108. If the workloads 104 are engaged in streaming data (including video data and/or audio data, for example), then each of the sampling rate SR, the behavior variation tolerance BVt, and the sensitivity variation tolerance SVt can be set low, where “low” can represent a lower value relative to higher values used for other types of workloads.

If the workloads 104 include transactional workloads (e.g., workloads for database transactions), then each of the sampling rate SR and the sensitivity variation tolerance SVt can be set medium (where “medium” can represent an intermediate value between a lower value and a higher value), and the behavior variation tolerance BVt can be set low.

If the workloads 104 include interactive workloads (e.g., involving interactions with users), then each of the sampling rate SR, the behavior variation tolerance BVt, and the sensitivity variation tolerance SVt can be set medium.

If the workloads 104 include workloads that process multi-dimensional data (having a large quantity of dimensions), then each of the sampling rate SR, the behavior variation tolerance BVt, and the sensitivity variation tolerance SVt can be set high, where “high” can represent a higher value relative to lower values used for other types of workloads.

In other examples, other settings may be specified for the foregoing workloads or other types of workloads. The settings may be set by a user, a program, or a machine.

The exfiltration detection engine 108 receives (at 202) a time series of metrics, collected at the sampling rate SR. It is assumed that the time series includes Nₜ samples (metrics collected at Nₜ time points according to the sampling rate SR), where Nₜ≥2. Nₜ represents how many samples are present in the time series of metrics at a current time t. As an additional sample of metrics is added to the time series as time t progresses, Nₜ is incremented by one.

It is assumed that each sample includes M metrics, where M≥2. For example, the M metrics in a given sample may include a CPU utilization metric and a data ratio metric representing the ratio between input data and output data. In further examples, the M metrics in the given sample may include more than two metrics.

The M metrics in sample i (i=1 to Nₜ) include x₁ᵢ, . . . , x_{Mi}. For example, x₁₁ can be the CPU utilization metric in sample 1, x₁₂ can be the CPU utilization metric in sample 2, and x_{1N}_{ₜ} can be the CPU utilization metric in sample Nₜ-Similarly, x_{M1} can be the data ratio metric in sample 1, x_{M2} can be the data ratio metric in sample 2, and x_{MN}_{ₜ} can be the data ratio metric in sample Nₜ. In the ensuing discussion, x₁ represents a first metric in any of the Nₜ samples, and x_{M} represents the M-th metric in any of the Nₜ samples. Thus, x₁ refers to any of x₁₁, . . . , x_{1N}_{ₜ}, and x_{M} refers to any of x_{M1}, . . . , x_{MN}_{ₜ}.

The exfiltration detection engine 108 computes (at 204) a moving average, μⱼ(t), of xⱼ as follows (where j is selected from 1 to M):

$${μ}_{j} ( t ) = {\sum }_{i = 1}^{{N}_{t}} {x}_{ji} / {N}_{t} . \qquad ( Eq . 1 )$$

The moving average, μⱼ(t), is generated based on the Nₜ samples present in the time series of metrics at time t. For each metric xⱼ, moving averages, μⱼ(t), are computed at respective different times t1, t2, . . . , t_{N}_{ₜ}, where t_{N}_{ₜ} is the latest time at which the Nₜ-th sample was acquired: μⱼ(t1), μⱼ(t2), . . . , μⱼ(t_{N}_{ₜ}). The computed moving averages, μⱼ(t1), μⱼ(t2), . . . , μⱼ(t_{N}_{ₜ}), are stored by the exfiltration detection engine 108 in a memory (not shown) of the computing system 100.

The exfiltration detection engine 108 computes (at 206) a moving standard deviation, σⱼ(t), of x, as follows:

$${σ}_{j} ( t ) = \sqrt{\frac{{\sum }_{i = 1}^{{N}_{t}} {( {x}_{ji} - {μ}_{j} ( t ) )}^{2}}{{N}_{t}}} . \qquad ( Eq . 2 )$$

Multiple moving standard deviations are computed at respective different times t1, t2, . . . , t_{N}_{ₜ}, and stored in the memory: σⱼ(t1), σⱼ(t2), . . . , σⱼ(t_{N}_{ₜ}).

A coefficient of variability, CV, for metric x, is based on μⱼ and σⱼ according to the following equation:

$${CV}_{j} = \frac{{μ}_{j} ( t )}{{σ}_{j} ( t )} . \qquad ( Eq . 3 )$$

CVⱼ represents the percent variation of the measured metric xⱼ from the moving standard deviation, σⱼ(t), of metric xⱼ.

The variability analyzer 114 in the exfiltration detection engine 108 computes (at 208) a predicted coefficient of variability, CVpⱼ, for metric xⱼ, as follows:

$${CVp}_{j} = ( {\sum }_{t = t 1}^{{t}_{{N}_{t}}} \frac{{μ}_{j} ( t )}{{σ}_{j} ( t )} ) / {N}_{t} . \qquad ( Eq . 4 )$$

For M metrics, the following predicted coefficients of variations are computed: CVp₁, . . . , CVp_{M}. CVpⱼ represents the predicted coefficient of variability for the next sample of metric xⱼ, Nₜ+1. Based on CVpⱼ, the variability analyzer 114 computes (at 210) a lower bound, LBpⱼ, and an upper bound, UBpⱼ, on the value of the coefficient of variability of the measured metric xⱼ for the next sample, Nₜ+1.

The lower bound, LBpⱼ, is calculated by decreasing the moving average, μⱼ(t_{N}_{ₜ}), by half the predicted coefficient of variability, CVpⱼ, and decreasing the result by the behavior variation tolerance, BVt:

$${LBp}_{j} = ( 1 - {CVp}_{j} / 2 ) {μ}_{j} ( {t}_{{N}_{t}} ) ( 1 - {BV}_{t} ) \qquad ( Eq . 5 )$$

The upper bound, UBpⱼ, is calculated by increasing the moving average, μⱼ(t_{N}_{ₜ}), by half the predicted coefficient of variability, CVpⱼ, and increasing the result by the behavior variation tolerance, BVₜ:

$${UBp}_{j} , = ( 1 + {CVp}_{j} / 2 ) {μ}_{j} ( {t}_{{N}_{t}} ) ( 1 + {BV}_{t} ) \qquad ( Eq . 6 )$$

For M metrics x₁, . . . , x_{M}, the following respective lower bounds and upper bounds are computed: LBp₁, . . . , LBp_{M} and UBp₁, . . . , UBp_{M}. In some examples, the values of CVpⱼ and BVₜ are expressed as percentages, so each of LBpⱼ and UBpⱼ is expressed as a percentage. Note that it is possible for UBpⱼ to be a percentage that is greater than 1.

In other examples, other ways of calculating the lower bound, LBpⱼ, and upper bound, UBpⱼ, for the coefficient of variability of metric xⱼ can be used.

The exfiltration detection engine 108 receives (at 212) metrics of the next sample, Nₜ+1. For each metric xⱼ in the next sample, the variability analyzer 114 computes (at 214) an actual coefficient of variability, CVαⱼ, as follows:

$${CVa}_{j} , = \vert \frac{{x}_{j}}{{xp}_{j}} - 1 \vert . \qquad ( Eq . 7 )$$

In Eq. 7, xpⱼ (the predicted value of metric xⱼ) is a moving average of values of xⱼ₁, . . . , x_{jN}_{ₜ} in samples 1 to Nₜ. Eq. 7 produces the absolute value of

$$\frac{{x}_{j}}{{xp}_{j}} - 1$$

(note that it is possible that

$$\frac{{x}_{j}}{{xp}_{j}} - 1$$

is a negative value, so the absolute value of

$$\frac{{x}_{j}}{{xp}_{j}} - 1$$

would produce the corresponding positive value). Effectively, CVαⱼ is derived as a percentage variation of the actual value of xⱼ in the next sample versus the predicted value (xpⱼ). More generally, CVαⱼ represents a variation of an actual value of metric xⱼ relative to a predicted value of metric xⱼ.

The variability analyzer 114 determines (at 216) if CVαⱼ for any metric xⱼ violates an anomalous behavior criterion. If so, the variability analyzer 114 makes a determination that metric xⱼ is exhibiting an anomalous behavior, and proceeds to perform task 216. However, if CVα₁, . . . , CVα_{M} for all M metrics do not violate the anomalous behavior criterion, then the variability analyzer 114 makes a determination that the workloads 104 of the computing system 100 are behaving as expected, and the process 200 returns to process further received metrics.

The determination of whether CVαⱼ for any metric xⱼ violates the anomalous behavior criterion can include determining whether CVα, for any metric xⱼ falls outside of the range defined by LBpⱼ and UBpⱼ. If CVαⱼ is outside of the range defined by LBpⱼ and UBpⱼ, i.e., CVαⱼ is less than LBpⱼ or CVαⱼ is greater than UBpⱼ, then metric xⱼ is considered to be exhibiting an anomalous behavior. Note that each of LBpⱼ and UBpⱼ is dependent upon the behavior variation tolerance, BVₜ. Adjusting the value (a percentage value) of BVₜ can tune the algorithm for detecting a metric exhibiting an anomalous behavior. Increasing the value of BVₜ may reduce false negatives but may increase false positives. On the other hand, reducing the value of BVₜ may increase false negatives but may decrease false positives.

In some examples, the exfiltration detection engine 108 can monitor false positives of detections of a metric exhibiting an anomalous behavior. If the rate of false positives exceeds a false positive threshold, then the exfiltration detection engine 108 may reduce the value of BVₜ. Similarly, if the rate of false negatives exceeds a false negative threshold, the exfiltration detection engine 108 may increase the value of BVₜ.

In other examples, the determination of whether CVₐⱼ for any metric xⱼ violates the anomalous behavior criterion can include determining whether CVₐⱼ for metric xⱼ exceeds BVₜ. If so, that indicates metric xⱼ is exhibiting an anomalous behavior.

If CVₐⱼ for any metric xⱼ violates the anomalous behavior criterion, the variability analyzer 114 builds (at 218) a coefficient of variability vector that includes the coefficients of variations for the M metrics: {CV_{α1}, . . . , CV_{αM}}. The sensitivity analyzer 116 analyzes the coefficient of variability vector to determine (at 220) a sensitive dependency across all M metrics. In some examples, the sensitivity dependency is determined by comparing the largest value in the coefficient of variability vector to the smallest value in the coefficient of variability vector. More specifically, the sensitivity analyzer 116 computes the sensitivity, CS, as a difference between the maximum and minimum values in the coefficient of variability vector:

$$CS = MAX ( {CV}_{a} ) - MIN ( {CV}_{a} ) . \qquad ( Eq . 8 )$$

In Eq. 8, MAX (CV_{α}) represents the maximum value in the coefficient of variability vector {CV_{α1}, . . . , CV_{αM}}, and MIN (CV_{α}) represents the minimum value in the coefficient of variability vector {CV_{α1}, . . . , CV_{αM}}.

The entropy detector 118 determines (at 222) whether CS violates the sensitivity variation tolerance, SVt. For example, the entropy detector 118 determines whether CS exceeds SVt. If CS does not violate SVt, then the entropy detector 118 makes a determination that the workloads 104 of the computing system 100 are behaving as expected, and the process 200 returns to process further received metrics.

However, if CS violates SVt, the entropy detector 118 outputs (at 224) the entropy indicator (EI) to the verifier 120. In some examples, a single occurrence of CS violating SVt would cause the entropy detector 118 to output the entropy indicator (EI). More generally, the entropy detector 118 outputs (at 222) the entropy indicator (EI) in response to detecting a specified quantity (represented by E (0)) of occurrences of CS violating SVt for the specified quantity of consecutive samples of metrics.

In response to EI, the verifier 120 analyzes a new time series of metrics to determine (at 226) whether the new time series of metrics shows the same pattern as the metrics in the original time series of metrics that triggered EI. If not (i.e., the new time series of metrics is exhibiting a new pattern different from the original time series), then the verifier 120 can produce (at 228) the exfiltration alert 122, which causes the remediation engine 110 to take a remediation action.

If the new time series of metrics shows the same pattern as the metrics in the original time series of metrics that triggered EI, the verifier 120 makes a determination that the workloads 104 of the computing system 100 are behaving as expected, and the process 200 returns to process further received metrics.

In further examples, the verifier 120 may also perform a scan of program code performing the workloads 104. The scan may include generating a cryptographic hash value (by applying a cryptographic hash function) based on the program code, and comparing the cryptographic hash value to a previously stored hash value to determine whether the program code has been compromised. A mismatch of the hash values indicates that an attack may be occurring, and the verifier 120 produces the exfiltration alert 122. A remediation action may be taken by the remediation engine 110 to address the potential attack.

If the hash values match, then that may indicate no attack is occurring, and the verifier 120 does not produce the exfiltration alert 122.

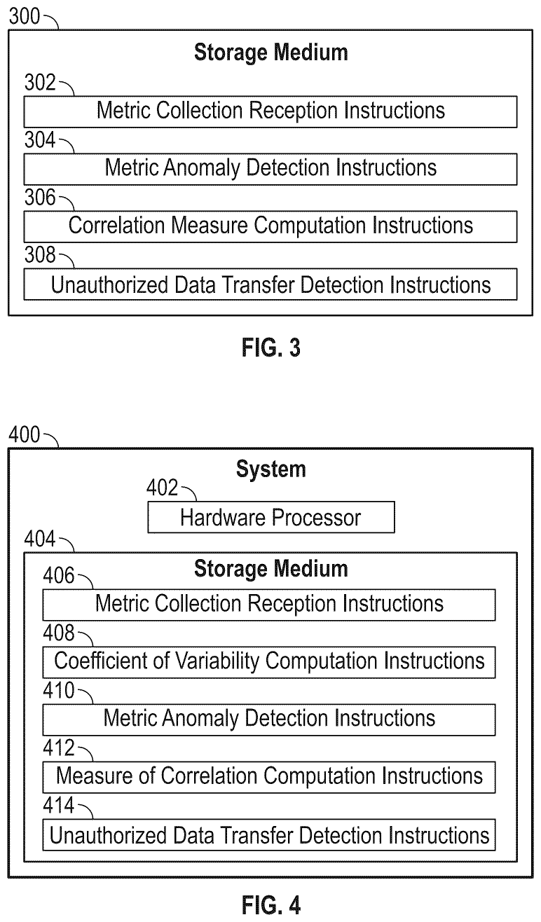

FIG. 3 is a block diagram of a non-transitory machine-readable or computer-readable storage medium 300 storing machine-readable instructions that upon execution cause a system to perform various tasks. The system can include one or more computers.

The machine-readable instructions include metric collection reception instructions 302 to receive a first collection of values of a plurality of metrics. The plurality of metrics include a resource utilization metric representing utilization of a resource (e.g., a CPU utilization metric or a metric representing the utilization of another type of resource), and a data communication metric representing communication of data (e.g., a data ratio metric). The first collection of values of the plurality of metrics can include a first time series of values of the plurality of metrics.

The machine-readable instructions include metric anomaly detection instructions 304 to detect an anomalous behavior of a first metric of the plurality of metrics. In some examples, the detection of the anomalous behavior of the first metric may be based on a coefficient of variability (e.g., CV_{αj}) computed for the first metric.

The machine-readable instructions include correlation measure computation instructions 306 to, based on detecting the anomalous behavior of the first metric, compute a measure of correlation between the first metric and at least a second metric of the plurality of metrics. In some examples, the measure of correlation can include a coefficient of sensitivity, CS.

The machine-readable instructions include unauthorized data transfer detection instructions 308 to determine whether an unauthorized data transfer is occurring based on the measure of correlation. For example, the unauthorized data transfer detection instructions 308 can compare the measure of correlation to a sensitivity variation tolerance (e.g., SVt).

In some examples, the machine-readable instructions can compute a first coefficient of variability for the first metric. The first coefficient of variability represents a variation of an actual value of the first metric relative to a predicted value of the first metric. The machine-readable instructions can detect the anomalous behavior of the first metric based on the first coefficient of variability for the first metric.

In some examples, the detecting of the anomalous behavior of the first metric is based on determining whether the first coefficient of variability violates an anomalous behavior criterion. For example, the machine-readable instructions can determine whether the first coefficient of variability falls outside a range defined by a lower bound (e.g., LBpⱼ) and an upper bound (UBpⱼ) on coefficient of variability values.

In some examples, the machine-readable instructions can compute a second coefficient of variability for the second metric. The second coefficient of variability represents a variation of an actual value of the second metric relative to a predicted value of the second metric. The machine-readable instructions can compute the measure of correlation using the first coefficient of variability and the second coefficient of variability.

In some examples, the machine-readable instructions can compute the measure of correlation based on a maximum of a plurality of coefficients of variability and a minimum of the plurality of coefficients of variability, the plurality of coefficients of variability including the first coefficient of variability and the second coefficient of variability.

In some examples, the machine-readable instructions can compute a third coefficient of variability for a third metric of the plurality of metrics, the third coefficient of variability representing a variation of an actual value of the third metric relative to a predicted value of the third metric. The machine-readable instructions can compute the measure of correlation using a plurality of coefficients of variability for respective metrics of the plurality of metrics, the plurality of coefficients of variability including the first coefficient of variability, the second coefficient of variability, and the third coefficient of variability.

In some examples, the machine-readable instructions can determine whether the unauthorized data transfer is occurring based on comparing the measure of correlation to a sensitivity tolerance (e.g., SVt).

In some examples, in response to detecting that the measure of correlation violates a sensitivity tolerance, the machine-readable instructions can perform the following. The machine-readable instructions can monitor a second collection of values of the plurality of metrics (e.g., a new time series of metrics), determine whether the second collection of values of the plurality of metrics exhibits a pattern matching a pattern of the first collection of values of the plurality of metrics, and determine that the unauthorized data transfer is occurring based on determining that the pattern of the second collection of values of the plurality of metrics does not match the pattern of the first collection of values of the plurality of metrics.

In some examples, determining that the pattern of the second collection of values of the plurality of metrics matches the pattern of the first collection of values of the plurality of metrics is based on detecting that the measure of correlation (e.g., CS) computed for the first collection of values of the plurality of metrics is within a threshold difference of a measure of correlation computed for the second collection of values of the plurality of metrics. Determining that the pattern of the second collection of values of the plurality of metrics matches the pattern of the first collection of values of the plurality of metrics may further be based on detecting that a coefficient of variability (e.g., CV) computed for the first collection of values of the plurality of metrics is within the threshold difference of a coefficient of variability computed for the second collection of values of the plurality of metrics.

In some examples, the resource utilization metric includes a processing resource utilization metric representing utilization of a processing resource.

In some examples, the data communication metric is based on a relation (e.g., ratio) between an amount of input data and an amount of output data.

In some examples, the resource utilization metric includes a memory utilization metric representing utilization of a memory.

In some examples, the data communication metric represents an amount of data read from a storage.

In some examples, the detecting of the anomalous behavior of the first metric and the determining of whether the unauthorized data transfer is occurring is based on a specified tolerance (e.g., BVₜ). The machine-readable instructions can adjust the specified tolerance in response to detecting a false positive rate above a false positive threshold or a false negative rate above a false negative threshold.

FIG. 4 is a block diagram of a system 400 according to some examples of the present disclosure. The system 400 includes a hardware processor 402 (or multiple hardware processors). A hardware processor can include a microprocessor, a core of a multi-core microprocessor, a microcontroller, a programmable integrated circuit, a programmable gate array, or another hardware processing circuit.

The system 400 includes a storage medium 404 storing machine-readable instructions executable on the hardware processor 402 to perform various tasks. Machine-readable instructions executable on a hardware processor can refer to the instructions executable on a single hardware processor or the instructions executable on multiple hardware processors.

The machine-readable instructions in the storage medium 404 include metric collection reception instructions 406 to receive a collection of values of a plurality of metrics including a resource utilization metric representing utilization of a resource, and a data communication metric representing communication of data.

The machine-readable instructions in the storage medium 404 include coefficient of variability computation instructions 408 to compute a coefficient of variability (e.g., CV_{αj}) of each respective metric of the plurality of metrics. The coefficient of variability represents a variation of an actual value of the respective metric relative to a predicted value of the respective metric.

The machine-readable instructions in the storage medium 404 include metric anomaly detection instructions 410 to detect an anomalous behavior of a first metric of the plurality of metrics based on the coefficient of variability of the first metric. The machine-readable instructions can determine whether the coefficient of variability of the first metric violates an anomalous behavior criterion.

The machine-readable instructions in the storage medium 404 include measure of correlation computation instructions 412 to, based on detecting the anomalous behavior of the first metric, compute a measure of correlation between the first metric and at least a second metric of the plurality of metrics. An example of the measure of correlation is CS.

The machine-readable instructions in the storage medium 404 include unauthorized data transfer detection instructions 414 to determine whether an unauthorized data transfer is occurring based on the measure of correlation. For example, if the measure of correlation violates a sensitivity tolerance (e.g., SVt), then the machine-readable instructions can monitor a new collection of metrics to determine whether the unauthorized data transfer is occurring.

In some examples, the measure of correlation between the first metric and the second metric indicates whether the second metric exhibits a proportionate variation with a variation of the first metric.

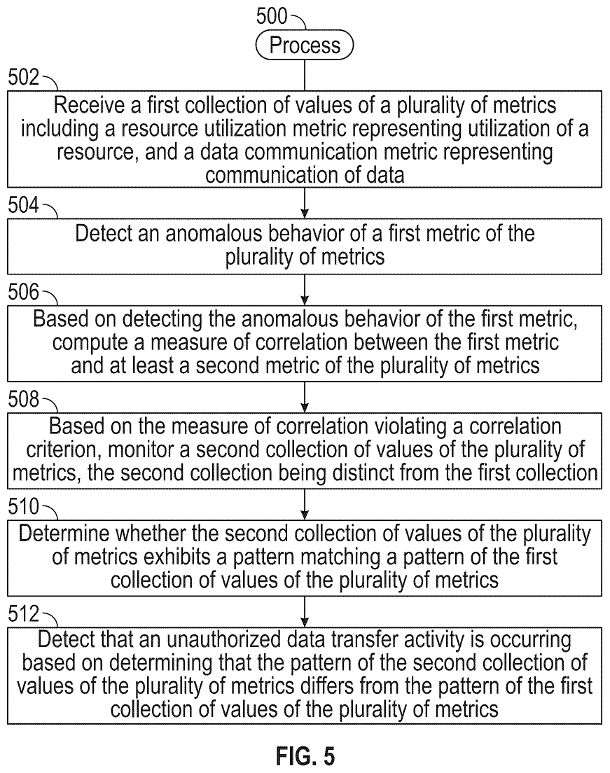

FIG. 5 is a flow diagram of a process 500 according to some examples of the present disclosure. The process 500 may be performed by the exfiltration detection engine 108, for example.

The process 500 includes receiving (at 502) a first collection of values of a plurality of metrics including a resource utilization metric representing utilization of a resource, and a data communication metric representing communication of data. The first collection can be a first time series of metrics.

The process 500 includes detecting (at 504) an anomalous behavior of a first metric of the plurality of metrics. The detection of the anomalous behavior of the first metric can be based on a coefficient of variability computed for the first metric, for example.

The process 500 includes, based on detecting the anomalous behavior of the first metric, computing (at 506) a measure of correlation between the first metric and at least a second metric of the plurality of metrics. The measure of correlation can be the coefficient of sensitivity, CS, for example.

The process 500 includes, based on the measure of correlation violating a correlation criterion, monitoring (at 508) a second collection of values of the plurality of metrics, the second collection being distinct from the first collection. The second collection can be a new time series of metrics. The measure of correlation violating the correlation criterion can include CS exceeding SVt, for example.

The process 500 includes determining (at 510) whether the second collection of values of the plurality of metrics exhibits a pattern matching a pattern of the first collection of values of the plurality of metrics.

The process 500 includes detecting (at 512) that an unauthorized data transfer activity is occurring based on determining that the pattern of the second collection of values of the plurality of metrics differs from (i.e., does not match) the pattern of the first collection of values of the plurality of metrics.

In some examples, the determination that the pattern of the second collection of values of the plurality of metrics matches the pattern of the first collection of values of the plurality of metrics is based on detecting that a measure of correlation computed for the second collection is within a threshold difference of the measure of correlation computed for the first collection.

As used here, an “engine” can refer to one or more hardware processing circuits, which can include any or some combination of a microprocessor, a core of a multi-core microprocessor, a microcontroller, a programmable integrated circuit, a programmable gate array, or another hardware processing circuit. Alternatively, an “engine” can refer to a combination of one or more hardware processing circuits and machine-readable instructions (software and/or firmware) executable on the one or more hardware processing circuits.

In FIG. 1, the variability analyzer 114, the sensitivity analyzer 116, the entropy detector 118, and the verifier 120 can be implemented with portions of the hardware processing circuitry of the exfiltration detection engine 108 or with machine-readable instructions executable by the exfiltration detection engine 108.

A variable can “exceed” a threshold or tolerance if the variable is greater than (or greater than or equal to) the threshold or tolerance.

A “memory” can include one or more memory devices. A memory device can include any or some combination of the following: a dynamic or static random access memory (DRAM or SRAM) device, an erasable and programmable read-only memory (EPROM) v, an electrically erasable and programmable read-only memory (EEPROM) device, or a flash memory device.

FIG. 2 and FIG. 5 show tasks in a specific order. In other examples, the tasks may be performed in a different order, some tasks may be omitted, and other tasks may be added.

A storage medium (e.g., 300 in FIG. 3 or 404 in FIG. 4) can include any or some combination of the following: a semiconductor memory device such as a DRAM or SRAM device, an EPROM device, an EEPROM device, or a flash memory device; a magnetic disk such as a fixed, floppy and removable disk; another magnetic medium including tape; an optical medium such as a compact disk (CD) or a digital video disk (DVD); or another type of storage device. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In the present disclosure, use of the term “a,” “an,” or “the” is intended to include the plural forms as well, unless the context clearly indicates otherwise. Also, the term “includes,” “including,” “comprises,” “comprising,” “have,” or “having” when used in this disclosure specifies the presence of the stated elements, but do not preclude the presence or addition of other elements.

In the foregoing description, numerous details are set forth to provide an understanding of the subject disclosed herein. However, implementations may be practiced without some of these details. Other implementations may include modifications and variations from the details discussed above. It is intended that the appended claims cover such modifications and variations.

What is claimed is:

1. A non-transitory machine-readable storage medium comprising instructions that upon execution cause a system to:
receive a first collection of values of a plurality of metrics comprising a resource utilization metric representing utilization of a resource, and a data communication metric representing communication of data;
detect an anomalous behavior of a first metric of the plurality of metrics;
based on detecting the anomalous behavior of the first metric, compute a measure of correlation between the first metric and at least a second metric of the plurality of metrics; and
determine whether an unauthorized data transfer is occurring based on the measure of correlation.

2. The non-transitory machine-readable storage medium of claim 1, wherein the instructions upon execution cause the system to:
compute a first coefficient of variability for the first metric, the first coefficient of variability representing a variation of an actual value of the first metric relative to a predicted value of the first metric; and
detect the anomalous behavior of the first metric based on the first coefficient of variability for the first metric.

3. The non-transitory machine-readable storage medium of claim 2, wherein the detecting of the anomalous behavior of the first metric is based on determining whether the first coefficient of variability violates an anomalous behavior criterion.

4. The non-transitory machine-readable storage medium of claim 2, wherein the instructions upon execution cause the system to:
compute a second coefficient of variability for the second metric, the second coefficient of variability representing a variation of an actual value of the second metric relative to a predicted value of the second metric; and
compute the measure of correlation using the first coefficient of variability and the second coefficient of variability.

5. The non-transitory machine-readable storage medium of claim 4, wherein the instructions upon execution cause the system to:
compute a third coefficient of variability for a third metric of the plurality of metrics, the third coefficient of variability representing a variation of an actual value of the third metric relative to a predicted value of the third metric; and
compute the measure of correlation using a plurality of coefficients of variability for respective metrics of the plurality of metrics, the plurality of coefficients of variability comprising the first coefficient of variability, the second coefficient of variability, and the third coefficient of variability.

6. The non-transitory machine-readable storage medium of claim 4, wherein the instructions upon execution cause the system to:
compute the measure of correlation based on a maximum of a plurality of coefficients of variability and a minimum of the plurality of coefficients of variability, the plurality of coefficients of variability comprising the first coefficient of variability and the second coefficient of variability.

7. The non-transitory machine-readable storage medium of claim 4, wherein the instructions upon execution cause the system to:
determine whether the unauthorized data transfer is occurring based on comparing the measure of correlation to a sensitivity tolerance.

8. The non-transitory machine-readable storage medium of claim 1, wherein the instructions upon execution cause the system to:
in response to detecting that the measure of correlation violates a sensitivity tolerance:
monitor a second collection of values of the plurality of metrics,
determine whether the second collection of values of the plurality of metrics exhibits a pattern matching a pattern of the first collection of values of the plurality of metrics, and
determine that the unauthorized data transfer is occurring based on determining that the pattern of the second collection of values of the plurality of metrics does not match the pattern of the first collection of values of the plurality of metrics.

9. The non-transitory machine-readable storage medium of claim 8, wherein the instructions upon execution cause the system to:
determine that the pattern of the second collection of values of the plurality of metrics matches the pattern of the first collection of values of the plurality of metrics based on detecting that the measure of correlation computed for the first collection of values of the plurality of metrics is within a threshold difference of a measure of correlation computed for the second collection of values of the plurality of metrics.

10. The non-transitory machine-readable storage medium of claim 1, wherein the resource utilization metric comprises a processing resource utilization metric representing utilization of a processing resource.

11. The non-transitory machine-readable storage medium of claim 1, wherein the data communication metric is based on a relation between an amount of input data and an amount of output data.

12. The non-transitory machine-readable storage medium of claim 1, wherein the resource utilization metric comprises a memory utilization metric representing utilization of a memory.

13. The non-transitory machine-readable storage medium of claim 1, wherein the data communication metric represents an amount of data read from a storage.

14. The non-transitory machine-readable storage medium of claim 1, wherein the detecting of the anomalous behavior of the first metric and the determining of whether the unauthorized data transfer is occurring is based on a specified tolerance, and wherein the instructions upon execution cause the system to:
adjust the specified tolerance in response to detecting a false positive rate above a false positive threshold or a false negative rate above a false negative threshold.

15. A system comprising:
a hardware processor; and
a non-transitory storage medium storing instructions executable on the hardware processor to:
receive a collection of values of a plurality of metrics comprising a resource utilization metric representing utilization of a resource, and a data communication metric representing communication of data;
compute a coefficient of variability of each respective metric of the plurality of metrics, the coefficient of variability representing a variation of an actual value of the respective metric relative to a predicted value of the respective metric;
detect an anomalous behavior of a first metric of the plurality of metrics based on the coefficient of variability of the first metric;
based on detecting the anomalous behavior of the first metric, compute a measure of correlation between the first metric and at least a second metric of the plurality of metrics; and
determine whether an unauthorized data transfer is occurring based on the measure of correlation.

16. The system of claim 15, wherein the detecting of the anomalous behavior of a first metric of the plurality of metrics based on the coefficient of variability of the first metric is based on determining whether the coefficient of variability of the first metric violates an anomalous behavior criterion.

17. The system of claim 16, wherein the coefficient of variability of the first metric violates the anomalous behavior criterion if:
the coefficient of variability of the first metric falls outside a range defined by a lower bound and an upper bound of coefficient of variability values, or
the coefficient of variability of the first metric exceeds a behavior variation tolerance.

18. The system of claim 15, wherein the measure of correlation between the first metric and the second metric indicates whether the second metric exhibits a proportionate variation with a variation of the first metric.

19. A method comprising:
receiving, by a system comprising a hardware processor, a first collection of values of a plurality of metrics comprising a resource utilization metric representing utilization of a resource, and a data communication metric representing communication of data;
detecting, by the system, an anomalous behavior of a first metric of the plurality of metrics;
based on detecting the anomalous behavior of the first metric, computing, by the system, a measure of correlation between the first metric and at least a second metric of the plurality of metrics;
based on the measure of correlation violating a correlation criterion, monitoring, by the system, a second collection of values of the plurality of metrics, the second collection being distinct from the first collection;
determining, by the system, whether the second collection of values of the plurality of metrics exhibits a pattern matching a pattern of the first collection of values of the plurality of metrics; and
detecting, by the system, that an unauthorized data transfer is occurring based on determining that the pattern of the second collection of values of the plurality of metrics differs from the pattern of the first collection of values of the plurality of metrics.

20. The method of claim 19, wherein the determining that the pattern of the second collection of values of the plurality of metrics matches the pattern of the first collection of values of the plurality of metrics is based on detecting that a measure of correlation computed for the second collection is within a threshold difference of the measure of correlation computed for the first collection.
